(19) United States
(12) Patent Application Publication
(10) Pub. No.: US 2013/0335829 A1
(43) Pub. Date: Dec. 19, 2013

(54) BI-TELECENTRIC INTERFEROMETER CONTINUOUS ZOOM IMAGING DEVICE

(71) Applicants: HSIEN-HUNG MENG, HSINCHU CITY (TW); SHIN-GWO SHIUE, HSINCHU CITY (TW); JIM CHUNG, HSINCHU CITY (TW)

(72) Inventors: HSIEN-HUNG MENG, HSINCHU CITY (TW); SHIN-GWO SHIUE, HSINCHU CITY (TW); JIM CHUNG, HSINCHU CITY (TW)

(73) Assignee: HSINTEK OPTICAL INSTRUMENT CO., HSINCHU CITY (TW)

(21) Appl. No.: 13/495,065

(22) Filed: Jun. 13, 2012

(51) Int. Cl. G02B 13/22

(52) U.S. Cl. 359/663

(57) ABSTRACT

A bi-telecentric interferometer continuous zoom imaging device, wherein a collimation object lens set, a telecentric imaging module, a telecentric continuous zoom module, and a CCD of modular design are formed on an integral circular tube main body, and can be calibrated and positioned separately. Then, a multi-partition isolation design is used to partition a housing into independent space for said various modules, to facilitate maintenance and also achieve customization. Collimation object lens set converts parallel light beams of interference pattern into a convergent light beam, and guides it to an imaging route through optical route adjusting means. Then, telecentric imaging module converts interference pattern on imaging route into an telecentric image parallel to optical axis, and telecentric continuous zoom module adjusts a magnifying ratio of telecentric image, then outputs an object image to form it on CCD, thus improving optical distortion and inferior resolution of the prior art.

### BACKGROUND OF THE INVENTION

1. Field of the Invention

The present invention relates to a bi-telecentric interferometer continuous zoom imaging device, and in particular to a bi-telecentric interferometer continuous zoom imaging device, that is modular in design and capable of facilitating assembly, repair, maintenance, and customization, to minimize optical distortion through bi telecentric imaging, hereby raising the measuring precision for object at large distance.

2. The Prior Arts

Along with the progress and development of precision measurement technology, the precise measurement of minute elements can be realized through optical means. Due to its advantages of high accuracy and non-destruction, it has been used widely in various sectors of the Industries. In this respect, an interferometer that is an opto-mechanical equipment capable of measuring optical elements or other physical quantities by means of optical interference is taken as example for explanation. Presently, the design and assembly of the opto-mechanical equipment is rather complicated, and the calibrated optical route is easy to be affected by external forces to induce optical axis deviations, hereby causing difficulty in maintenance. By way of example, the optical-mechanical equipment is a main body structure formed by a plurality of components, and most of the optical elements are disposed in the main body structure. In assembling the optical elements in the main body structure, the optical elements must be calibrated and positioned in place, to ensure the accuracy of the optical route.

However, during transportation, the main body structure is apt to have the problem of insufficient stiffness due to its design structure, thus leading to the possibility of optical route deviation. Moreover, upon being impacted from outside, the main body structure will generate vibrations, hereby producing optical route deviations. Furthermore, since the optical elements are not modularized, and are placed separately in the main body structure, such that when some of the elements break down, the entire structure must be detached, checked, repaired, or replaced, and that is tedious, costly, time consuming, and of low efficiency. In addition, the CCD of the optical-mechanical device and the attached lens are heavy and voluminous. In adjusting focus, CCD has to be adjusted, to cooperate with the imaging plane, and that will cause the vibration and deviations of gravitational center of the entire main-body structure, hereby making the process of adjusting the CCD and lens very complicated.

In addition to the shortcomings of the conventional opto-mechanical device mentioned above, the quality of the interference fringes depends on the imaging system, so that when the distance to the object-to-be-measured is changed, the magnification ratio, distortion, and resolution of the imaging system are changed, thus affecting its accuracy of measurement.

Therefore, presently, the design and performance of continuous zoom imaging device are not quite satisfactory, and it has much room for improvements.

### SUMMARY OF THE INVENTION

In view of the problems and drawbacks of the prior art, a major objective of the present invention is to provide a bi-telecentric interferometer continuous zoom imaging device, so that various optical modules can be assembled integrally into a machine body, so as to raise its overall stiffness, facilitate assembly and maintenance, and reduce the possibility of optical route deviation.

Another objective of the present invention is to provide a bi-telecentric interferometer continuous zoom imaging device. Wherein, a bi-section telecentric lens imaging approach is adopted to provide wide field depth, thus making it advantageous for measuring non-planar objects, while keeping the size of interference fringe image without being affected by object distance, in achieving high quality image.

A further objective of the present invention is to provide a a single magnification system by removing the continuous zoom module, to increase the convenience and flexibility of applying the system.

A yet another objective of the present invention is to provide a bi-telecentric interferometer continuous zoom imaging device. Wherein, flexible hanging components are used to reduce the impact to optical module from outside or vibrations during transportation.

A further objective of the present invention is to provide a bi-telecentric interferometer continuous zoom imaging device. Wherein, multi partitions are provided, to effectively ward off dusts and particles from entering and affecting the optical modules, such that each optical module can be assembled, detached, repaired, or replaced separately, to achieve better flexibility of the entire structure.

In order to achieve the objective mentioned above, the present invention provides a bi-telecentric interferometer continuous zoom imaging device, comprising: a circular tube main body, a collimation object lens set, a telecentric imaging module, a telecentric continuous zoom module, and a Charged Coupled Device (CCD). Firstly, to form the collimation object lens set, the telecentric imaging module, the telecentric continuous zoom module, and the CCD of modular design integrally onto the circular tube main body, that are adjusted and positioned in advance respectively, so that they can be replaced by modules when necessary, to raise the maintenance efficiency and save cost. Wherein, a light projector is used to project a light beam, such as a laser light beam into a collimation object lens set, that is reflected and modulated into parallel light beams of interference pattern, then it is converted into a convergent light beam, and it is guided onto an imaging route. The telecentric imaging module is located in front of a collimation object lens set, and is used to convert the interference patterns on the imaging route into a telecentric image, to enlarge the field depth and keep the magnification ratio of the interference fringe image unchanged without being affected by the distance to the object-to-be-measured. The telecentric continuous zoom module disposed between the collimation object lens set and the telecentric imaging module is used to adjust the magnification ratio of the telecentric imaging, and then it outputs an object image. Finally, the object image is formed directly on a Charge Couple Device, and is converted into electronic signals. As such, through the modular design and the arrangement of the optical elements mentioned above, the occurrences of optical route deviations can be effectively reduced.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a perspective view of a bi-telecentric interferometer continuous zoom imaging device according to the present invention;

FIG. 2 is an enlarged view of a portion of optical module according to the present invention; and

FIG. 3 is a schematic diagram of a portion of a bi-telecentric interferometer continuous zoom imaging device according to the present invention used to prevention vibration;

FIG. 4 is a schematic diagram of a portion of a bi-telecentric interferometer continuous zoom imaging device according to the present invention having multi-partition design; and

FIG. 5 is a schematic diagram of an optical route for a bi-telecentric interferometer continuous zoom imaging device according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The structure of conventional optical-mechanical device is rather complicated, and optical route deviations are liable to occur due to impact from outside or vibration during transportation, such that its transportability is insufficient and it assembly, detachment, and maintenance are complicated and inconvenient. In order to improve the shortcomings of the prior art, the present invention provides a bi-telecentric interferometer continuous zoom imaging device, to raise its overall performance and stability in application.

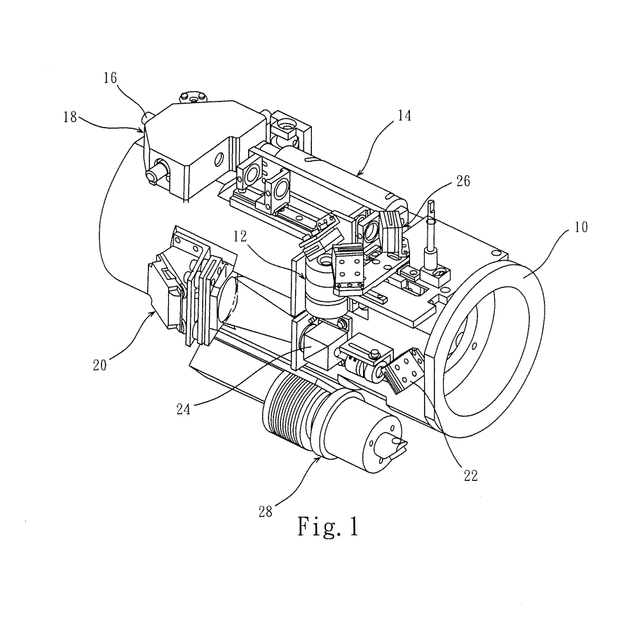

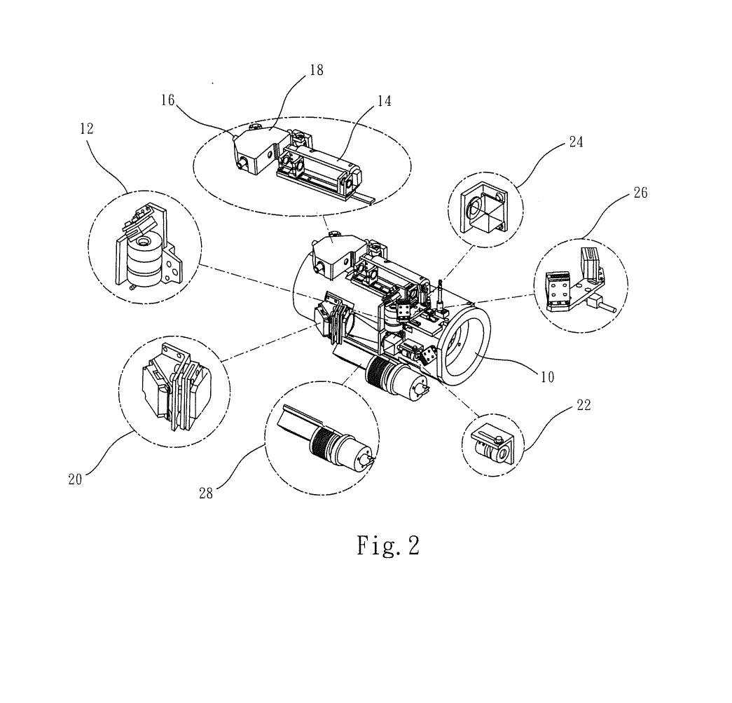

Firstly, the improvement of structure design is described in detail. Refer to FIGS. 1 and 2 for a perspective view of a bi-telecentric interferometer continuous zoom imaging device according to the present invention, and an enlarged view of a portion of optical module according to the present invention respectively. As shown in FIG. 1, the bi-telecentric interferometer continuous zoom imaging device of the present invention includes: circular tube main body 10, and a telecentric imaging module 12, a telecentric continuous zoom module 14; and a Charged Coupled Device (CCD) 16. Wherein, the circular tube main body 10 is integrally formed with an alloy containing aluminum, to raise its overall stiffness, hereby solving the problem of the prior art of insufficient stiffness of the device, since it is made by a plurality of components connected together.

The collimation object lens set converts the parallel light beams of the interference patterns into convergent light beams, and guides them onto an imaging route. Wherein, the collimation object lens set includes two planes (not shown), a collimation device 18, a calibration beam splitter 20, a diffuser set 22, a polarizing beam splitter (PBS) 24, and a reflection mirror set 26. The calibration beam splitter 20 and the polarizing beam splitter 24 are located below the two planes and the collimation device 18. The polarizing beam splitter 24 and diffuser set 22, and calibration beam splitter 20 are disposed in a coplanar horizontal arrangement, such that the polarizing beam splitter 24 are located between the calibration beam splitter set 20 and the diffuser set 22. The telecentric imaging module 12 is provided in front of the collimation object lens set, and the telecentric imaging module 12 converts the interference pattern on the imaging route into a telecentric image. The reflection mirror set 26 is disposed between the telecentric imaging module 12 and the telecentric continuous zoom module 14, so that the reflection mirror set 26 reflects the telecentric image to the telecentric continuous zoom module 14, and that adjusts the magnification ratio of the telecentric image and outputs an object image. The Charged Coupled Device 16 is provided on a side of the telecentric continuous zoom module 14, such that the object image is formed on Charged Coupled Device 16, and is converted into electronic signals.

In the descriptions mentioned above, The bi-telecentric interferometer continuous zoom imaging device further includes a light projector 28 to produce projection light, that is disposed on the outer side of the circular tube main body 10, and is below the polarizing beam splitter 24. Since the telecentric imaging module 12, the telecentric continuous zoom module 14, the Charged Coupled Device 16, the collimation object lens set, and the various optical elements are modularized, thus upon installing onto the circular tube main body 10, they can be calibrated and positioned in advance, such that during maintenance and repair, they can be replaced by modules, to raise the efficiency and reduce cost of repair and maintenance. Moreover, the optical modules can be designed and revised based directly on market demand in achieving customization. In addition, by combining the stiffness of the circular tube main body 10 and the modular design of the optical components, the occurrence of optical route deviation can be effectively reduced.

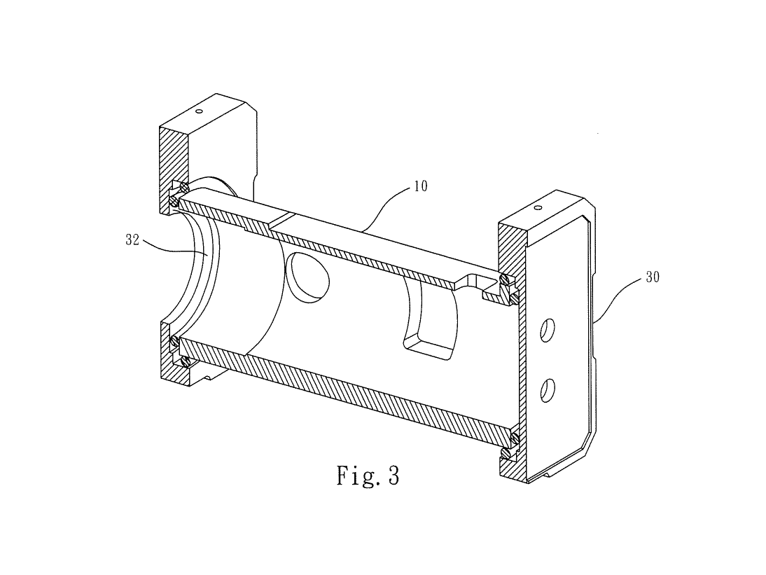

Subsequently, in order to further raise the vibration proof effect, refer to FIG. 3 for a schematic diagram of a portion of a bi-telecentric interferometer continuous zoom imaging device according to the present invention used to prevent vibration. As shown in FIG. 3, the bi-telecentric interferometer continuous zoom imaging device includes a housing 30, wherein is provided with a soft hanging component 32, so that two ends of the circular tube main body 10 are against and fixed onto the soft hanging component 32, to make the circular tube main body 10 position in the housing 30. The soft hanging component 32 is made of soft material having vibration proof effect, such that it can reduce significantly the impact from outside or vibrations during transportation for the various optical modules outside the circular tube main body 10, to enhance the stability of the overall structure and the optical route.

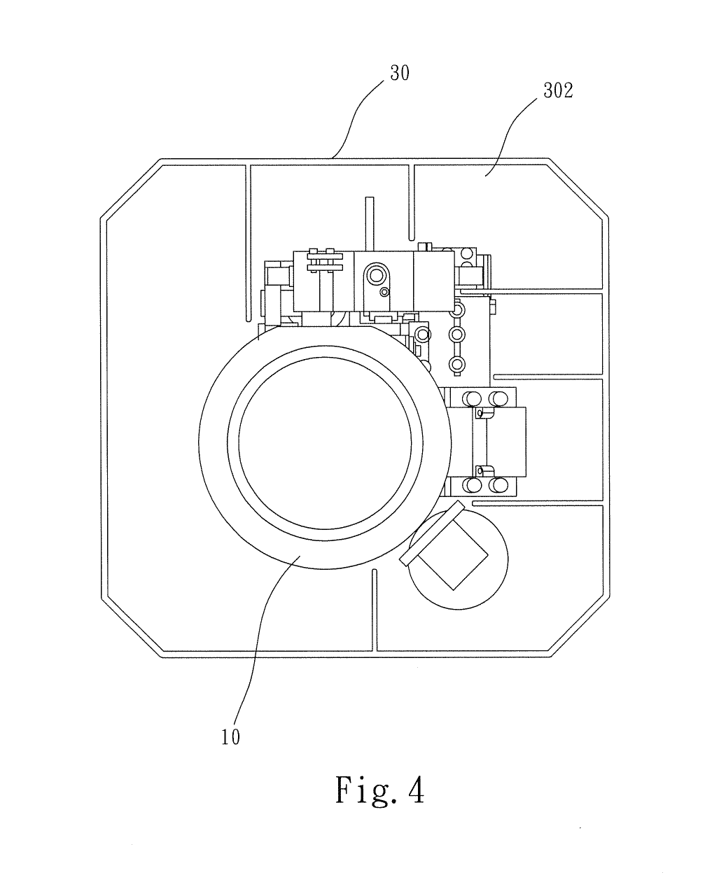

In the descriptions mentioned above, the housing 30 is of a multi-partition design. Refer to FIG. 4 for a schematic diagram of a portion of a bi-telecentric interferometer continuous zoom imaging device according to the present invention having multi-partition design. As shown in FIG. 4, the housing 30 includes a plurality of isolation cabins 302, correspond respectively to receive the various optical modules, such as the collimation object lens set, the telecentric imaging module 12, the telecentric continuous zoom module 14; and the Charged Coupled Device 16, so that all the optical modules are formed to have a separate and independent space. To be more specific, each optical module is provided and matched with an isolation cabin 302, so that each isolation cabin 302 can be opened separately. Therefore, each of the optical modules can be assembled, detached, repaired, and replaced separately, to make maintenance of the entire structure more flexible. In other words, for the optical modules not requiring repair, dusts and particles can be isolated effectively outside through the design of isolation cabin 302, so as to prevent the dust to produce noise on the imaging route.

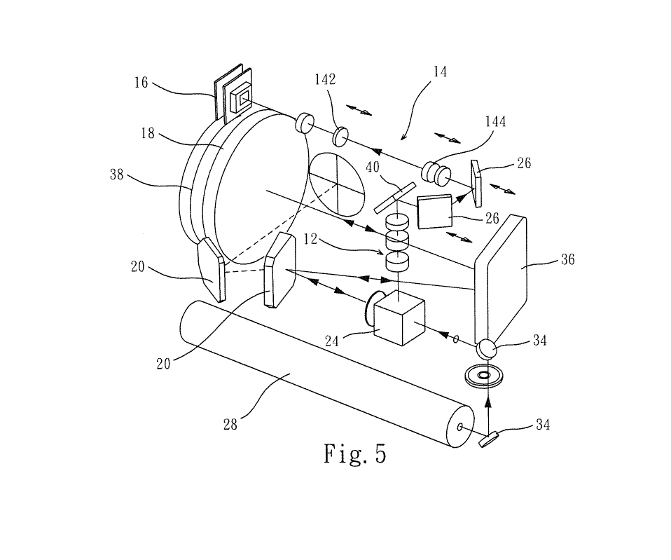

From the descriptions of the structure design mentioned above, it can be known that, the present invention does indeed solve the problems of the prior art. Of course, the present invention can also improve the optical performance of the bi-telecentric interferometer continuous zoom imaging device. Refer to FIGS. 1 and 5 at the same time. At least a reflection mirror 34 and a diffuser set 22 are provided on the optical route between a light projector 28 and a polarizing beam splitter 24. Wherein, the light projector 28 can be a laser device, that outputs a helium-neon laser light beam, and that is reflected by the reflection mirror 34 to the diffuser set 22, such that the diffuser set 22 diffuses the laser light beam and transmits it to the polarizing beam splitter 24. Wherein, an attenuator is further provided on the optical route of the light projector 28, that is mainly used to reduce the amplitude of the laser light beam, so that its phase and frequency will not be distorted, to achieve modulating the light. The polarizing beam splitter 24 includes a ¼ wave plate, such that the polarized light output from the polarizing beam splitter 24 is reflected, and changes its direction through the calibration beam splitter 20 and a primary mirror 36, then the light beam enters into a collimation device 18. In general, the collimation device 18 is made of collimation lenses, so that light beams may enter between the two planes 38. Wherein, the two planes 38 include a reference plane, and a test plane.

Then, the approach to achieve bi-telecentric optical imaging is described. Upon entering into between two planes 38, the light beam reflected by the reference plane and the light beam reflected by the test plane interfere with each other to form an interference pattern of the object-to-be-measured. Then, the collimation device 18 converts the parallel light beams of interference pattern into convergent light beams having interference fringes. Afterwards, the optical route adjusting means formed by the primary mirror 36 and the calibration beam splitter 20 guides the interference fringes from the collimation device 18 to the polarizing beam splitter 24. The polarizing beam splitter 24 reflects the interference fringes, and guides them onto an imaging route. Then, the telecentric imaging module 12 converts the interference pattern on the imaging route into a telecentric image parallel to the optical axis. As such, the telecentric imaging module 12 adjusts the interference pattern into telecentric images of constant magnification ratio, so as to keep the magnification ratio of the interference fringe image constant, without being affected by the distance to the object-to-be-measured. In the descriptions above, the telecentric imaging module 12 is preferably made of three relay lens sets.

Then, the telecentric continuous zoom module 14 is used to work in cooperation with the telecentric imaging module 12, with its optical adjustment means divides the telecentric optical imaging into two sections. Wherein, the collimation object lens set and the telecentric imaging module 12 constitute the front section focusing and imagining system, so that the chief ray entering the imaging side is made to parallel to the optical axis. The telecentric continuous zoom module 14 constitutes the rear section continuous zoom imaging system, so the chief ray on the object side is parallel to the optical axis, as such forming the bi-telecentric interferometer continuous zoom imaging device. To be more specific, in case the distance to the object-to-be-measured is changed thus requiring adjusting focus, the telecentric continuous zoom module 14 can be used to adjust the magnification ratio of the telecentric imaging. Wherein, a planar reflection mirror 40 is provided on the optical route between the telecentric imaging module 12 and the reflection mirror set 26, and it is on an imaging route. The telecentric image parallel to the optical axis is reflected in sequence through the planar reflection mirror 40 and the reflection mirror set 26, to guide the telecentric image paralleling to the optical axis to the telecentric continuous zoom module 14, to adjust the magnification ratio of the telecentric imaging.

More specifically, the telecentric continuous zoom module 14 can be zoomed between a factor of 1 (1×) and 6 (6×), to adjust the magnification ratio of the interference light on the imaging route, and output an object image. By way of example, the telecentric continuous zoom module 14 may include 4 zoom lenses, wherein, mainly the two zoom lenses 142 and 144 are required to be adjusted, such that through adjusting spacing between the two zoom lenses 142 and 144, the object image can be enlarged or reduced. The closer the spacing between the two zoom lenses 142 and 144, the larger the magnification ratio of the object image.

Since the telecentric continuous zoom module 14 is placed directly in the focal plane of a Charged Coupled Device 16, so that an object image can be formed directly onto the Charged Coupled Device 16, and then it is converted into electronic signals, as such the present invention can indeed improve the optical performance of the system. It is worth to note that, conventionally, focus adjusting is realized through adjusting Charged Coupled Device in cooperation with the imaging plane. However, the Charged Coupled Device and the attached lenses are heavy and voluminous, so their adjusting is complicated. In addition, the moving and shifting of large components inside the system is liable to cause deviation of gravitation center and vibrations. Therefore, the reflection mirror set 26 of the present invention is designed into two pieces of reflection mirrors having symmetrical inclination angle, such that through the forward and backward movements of the two pieces of the reflection mirrors, to adjust the position of the imaging plane in cooperation with Charged Coupled Device 16. Therefore, the Charged Coupled Device 16 and the attached lenses can be fixed securely on the circular tube main body 10, meanwhile, it is easy for replacement.

Of course, in the structure design of the present invention, optical modules can be replaced depending on measuring requirement. To redress the optical distortion of the prior art, the present invention provides a bi-section telecentric optical imaging system, so that the optical performance is not affected by zooming and field depth of the object-to-be-measured, meanwhile, size of interference fringe image is not affected by object distance, hereby achieving image of high quality. In addition, telecentric imaging module 12 can be used solely as a magnification ratio calibration device, however, the present invention is not limited to this. Therefore, the present invention does provide operation flexibility and convenience.

Summing up the above, the present invention provides a bi-telecentric interferometer continuous zoom imaging device, that is capable of improving structure defects of the prior art, increasing the overall stiffness, convenience of assembly, repair, and maintenance, and reducing occurrences of optical route deviation. In addition, it can raise optical performance, improve the problem of the prior art that optical distortion becomes serious when object distance becomes large, so that magnification ratio of the system is kept constant, in maintaining illumination of interference fringe image, and raising quality of optical imaging. The present invention is provided with the various advantages mentioned above, thus raising significantly the precision and applicability of optical measurement, and having a good competitive edge on the market.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A bi-telecentric interferometer continuous zoom imaging device, comprising:
a circular tube main body;
a collimation object lens set, disposed on said circular tube main body, to convert parallel light beam of interference patterns into a convergent light beam, and to guide it onto an imaging route;
a telecentric imaging module, disposed on said circular tube main body, and is located in front of said collimation object lens set, to convert said interference patterns on said imaging route into a telecentric image;
a telecentric continuous zoom module, disposed on said circular tube main body, and is located between said collimation object lens set and said telecentric imaging module, to adjust magnification ratio of said telecentric image, and output an object image; and
a Charged Coupled Device, disposed on said circular tube main body, and is located on a side of said telecentric continuous zoom module, so that said object image is formed on said Charged Coupled Device, to be converted into electronic signals.

2. The bi-telecentric interferometer continuous zoom imaging device as claimed in claim 1, wherein said circular tube main body is made of alloy containing aluminum.

3. The bi-telecentric interferometer continuous zoom imaging device as claimed in claim 1, further comprising: a housing, said circular tube main body is disposed in said housing, such that said housing contains a plurality of isolation cabins, to receive said collimation object lens set, said telecentric imaging module, said telecentric continuous zoom module, and said Charged Coupled Device, to form separate and independent space for components mentioned above.

4. The bi-telecentric interferometer continuous zoom imaging device as claimed in claim 3, wherein a soft hanging component is further provided in said housing, so that two ends of said circular tube main body are against and fixed onto said soft hanging component.

5. The bi-telecentric interferometer continuous zoom imaging device as claimed in claim 1, wherein said collimation object lens set includes two planes, a collimation device, and a polarizing beam splitter, said polarizing beam splitter is below said two planes and said collimation device, such that reflection light beams of said two planes interfere with each other to form said interference pattern of an object-to-be-measured, and said collimation device converts parallel light beams of said interference pattern into said convergent light beam, then said polarizing beam splitter guides said interference pattern onto said image route.

6. The bi-telecentric interferometer continuous zoom imaging device as claimed in claim 5, wherein a light projector of said interferometer provides light beam to said two planes, that is reflected into reflection light beam, said light projector is installed on said circular tube main body, and is below said polarizing beam splitter.

7. The bi-telecentric interferometer continuous zoom imaging device as claimed in claim 6, wherein said collimation object lens set further includes a calibration beam splitter, located on optical route between said light projector and said polarizing beam splitter, said calibration beam splitter is installed on said circular tube main body, and is disposed in parallel with said polarizing beam splitter.

8. The bi-telecentric interferometer continuous zoom imaging device as claimed in claim 1, wherein a reflection mirror set is provided between said telecentric imaging module and said telecentric continuous zoom module, to reflect said telecentric image parallel to said optical axis to said telecentric continuous zoom module, said reflection mirror set is installed on said circular tube main body.

9. The bi-telecentric interferometer continuous zoom imaging device as claimed in claim 1, wherein said telecentric imaging module adjusts said interference pattern into said telecentric image of a constant magnification ratio.

10. The bi-telecentric interferometer continuous zoom imaging device as claimed in claim 1, wherein said telecentric continuous zoom module adjusts spacing between at least two zoom lenses to magnify said object image, to zoom between a magnification factor of 1 and 6.

11. The bi-telecentric interferometer continuous zoom imaging device as claimed in claim 1, wherein said telecentric imaging module is a relay lens set.
